(19) United States
(12) Patent Application Publication
(10) Pub. No.: US 2006/0181419 A1
(43) Pub. Date: Aug. 17, 2006

(54) RFID tag applicable to metallic environment

(75) Inventors: Shih-Zong Chen, Yuanli Township (TW); Jian-Jhih Ciou, Gueishan Township (TW); Liang-Cin Wang, Kaohsiung City (TW)

Correspondence Address: John S. Egbert;Harrison & Egbert, 7th Floor, 412 Main Street, Houston, TX, 77002, US

(73) Assignee: Wha Yu Industrial Co., Ltd., Hsin Chu City (TW)

(21) Appl. No.: 11/044,312

(22) Filed: Jan. 28, 2005

(51) Int. Cl. G08B 13/14

(52) U.S. Cl. 340/572.1

(57) ABSTRACT

The RFID tag applicable to metallic environment, is fitted with a dielectric substrate adhered to conducting antenna. And, a wireless telecommunication IC is linked to antenna, which is provided with a radiator and a grounding terminal. The radiator is mounted onto the surface of dielectric substrate, and the grounding terminal is mounted onto the back of dielectric substrate. The entire antenna unit is available with a resonant mode or radiation mechanism, whereas a wireless telecommunication IC is electrically linked between radiator and grounding terminal. This complete structure of RFID tag enables correct read/write of reader/writer for use with metallic products.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a RFID tag, and more particularly to a RFID tag designed with special antenna for use with metals.

### BACKGROUND OF THE INVENTION

Generally, a Radio Frequency Identification (RFID) tag refers to the components including wireless telecommunication IC and antenna, by which data can be read or written in with the help of specific reader/writer. Thanks to the features of RFID that permit to search for information, such as IC and properties, via telecommunication mode, the business operators can provide cost-effective logistics services according to accurate flow direction of materials. Therefore, this tag is gradually replacing traditional bar codes and magnetic cards.

An operating mode, which combines “individuals”, “goods” with “environment” via RFID-based hyperlink, is currently applied to some commercial fields, such as logistics systems production management and log control, etc. However, the electric wave for RFID generally cannot pass through metals. In the case of metallic packages for household furniture, electronic devices and metal products or others, it is impossible to read the data of RFID. This is because that, once in touch with RFID, the metals receiving electric wave of reader/writer will also generate an electromagnetic field, which will counteract with that at exterior of RFID. To this end, it is difficult for RFID to generate radioactive electromagnetic induction, thus disabling the data exchange between reader/writer and RFID. As a typical solution, RFID is spaced properly with the contact area of metallic product. For this purpose, a spacer block of proper thickness shall be inserted into the back of RFID to minimize the interference of metallic product on RFID tag. Anyhow, this will increase the volume/thickness of RFID, but also lead to a higher manufacturing cost. So, this solution cannot really meet the expectations of the market.

Thus, to overcome the aforementioned problems of the prior art RFID structural design, it would be an advancement in the art to provide an improved structure that can solve the metal-related disadvantages for a higher efficiency.

To this end, the inventors have provided the present invention of practicability after deliberate design and evaluation based on years of experience in the production, development and design of related products.

### BRIEF SUMMARY OF THE INVENTION

As shown in FIGS. 3, 4 of the present invention, the grounding terminal 202 of antenna 20 will keep in touch with the surface of metallic product 40. In the presence of an existing grounding terminal 202 in the structure of antenna 20, radiator 201 and grounding terminal 202 of antenna 20 will generate a resonant mode or radiation mechanism in either electrical contact or surface contact or a spaced proximity between grounding terminal 202 and metallic product 40. In this way, once RFID tag of the present invention is adhered to the metals, a more efficient antenna radiation mechanism will be made available, for a bigger area of grounding terminal 202 will enable grounding terminal 202 to play a bigger role within antenna 20, namely, achieving a better radiation efficiency and wider communication distance for reader/writer 50. Thus, no spacer block is required for separation of RFID from metal surface in the present invention, nor additional components are required for dielectric substrate 10 to avoid wave interference from metals. So, the present invention has offered a modified structure of RFID tag, which, through adherence or electrical connection for metals, can facilitate the communication with reader/writer 50 and reduce the manufacturing cost without any spacers or addition of volume.

The above is a detailed description of the technical features of the present invention based on a typical preferred embodiment. However, it should be appreciated that the present invention is capable of a variety of embodiments and various modifications by those skilled in the art, and all such variations or changes shall be embraced within the scope of the following claims.

### BRIEF DESCRIPTION OF THE SEVERAL VIEWS OF THE DRAWINGS

FIG. 1 shows a perspective view of the surface of the present invention.

FIG. 2 shows a perspective view of the back of the present invention.

FIG. 3 shows a cross-sectional view of the present invention.

FIG. 4 shows a plane view of the application of the present invention on a metallic product.

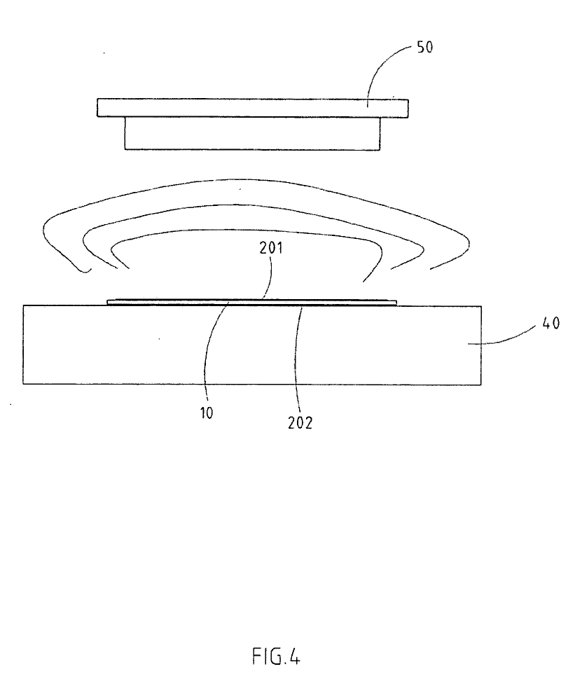

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

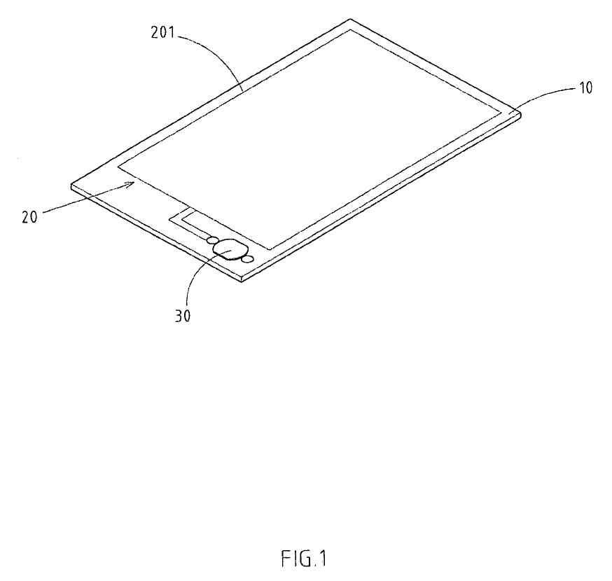

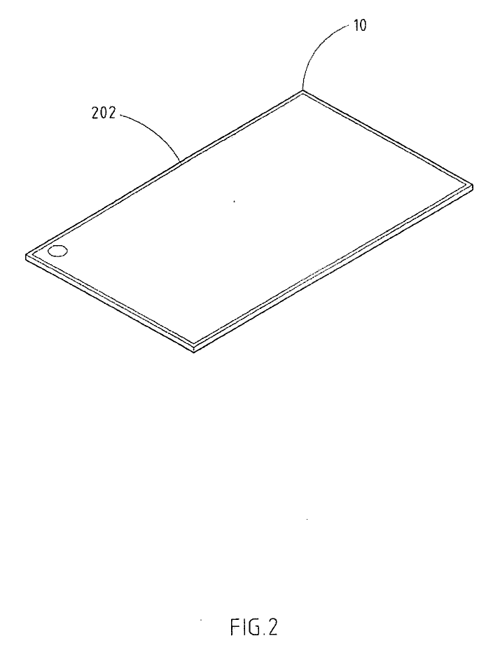

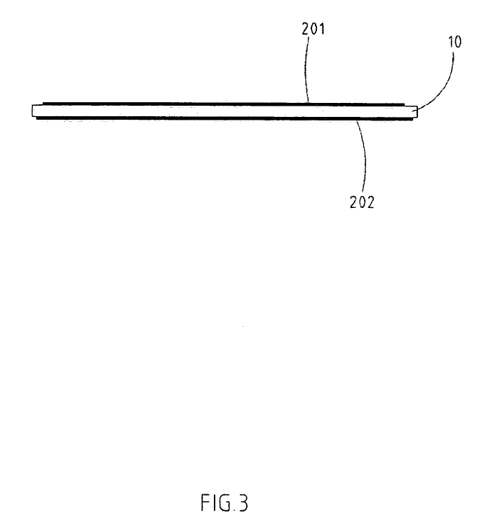

As shown in FIGS. 1-3, a RFID tag embodied in the present invention comprises:

a dielectric substrate 10, which is adhered to a conducting antenna 20. And, a wireless telecommunication IC 30 is linked to antenna 20, which is provided with a radiator 201 and a grounding terminal 202. The features lie in: the radiator 201 is mounted onto the surface of dielectric substrate 10, and the grounding terminal 202 onto the back of dielectric substrate 10. The entire antenna unit is available with a resonant mode or radiation mechanism, whereas a wireless telecommunication IC 30 is electrically linked between radiator 201 and grounding terminal 202.

1. A RFID tag applicable to metallic environment comprising:
a dielectric substrate, adhered to conducting an antenna; and
a wireless telecommunication IC linked to said antenna, being comprised of a radiator and a grounding terminal, said radiator being mounted onto a surface of dielectric substrate, and the grounding terminal being mounted onto a back of said dielectric substrate, the antenna having a resonant mode or radiation mechanism, wherein said wireless telecommunication IC is electrically linked between said radiator and said grounding terminal.
